(19) United States
(12) Patent Application Publication
(10) Pub. No.: US 2021/0194699 A1
(43) Pub. Date: Jun. 24, 2021

(54) BLOCKCHAIN-EMBEDDED SECURE DIGITAL CAMERA SYSTEM TO VERIFY AUDIOVISUAL AUTHENTICITY

(71) Applicant: THE TRUSTEES OF COLUMBIA UNIVERSITY IN THE CITY OF NEW YORK, New York, NY (US)

(72) Inventors: Nicholas TATONETTI, New York, NY (US); Siddhartha SHRIVASTAVA, Jersey City, NJ (US)

(73) Assignee: THE TRUSTEES OF COLUMBIA UNIVERSITY IN THE CITY OF NEW YORK, New York, NY (US)

(21) Appl. No.: 17/115,087

(22) Filed: Dec. 8, 2020

Related U.S. Application Data
(63) Continuation of application No. PCT/US2019/035195, filed on Jun. 3, 2019.
(60) Provisional application No. 62/682,567, filed on Jun. 8, 2018.

(51) Int. Cl. H04L 9/32; H04L 9/08; H04N 7/025

(52) U.S. Cl. CPC H04L 9/3239; H04L 9/0891; H04L 9/0877; G06F 1/14; H04L 2209/38; H04L 2209/60; H04N 7/025

(57) ABSTRACT

A system for collecting and distributing a digital audiovisual item captured by a sensor using a blockchain server is disclosed. The system can comprise a security module that is coupled to the sensor and adapted to generate a private cryptographic key. The system can further include a blockchain-enabled hardware, coupled to the sensor and the security module. The hardware can generate a set of original hashes corresponding to the captured digital audiovisual item and an identifier having an address to the original hashes, embed information corresponding to the identifier in the captured digital audiovisual item to create a blockchain identified audiovisual item, and post the set of original hashes to a public blockchain using the private cryptographic key. Methods for collecting and distributing a digital audiovisual item captured by a sensor using a blockchain server are also provided.

### CROSS REFERENCE TO RELATED APPLICATION

This application is a continuation of International Patent Application No. PCT/US2019/035195, filed Jun. 3, 2019, which claims the benefit of priority of U.S. Provisional Patent Application No. 62/682,567 filed Jun. 8, 2018, which are hereby incorporated by reference in their entireties.

### BACKGROUND

Digital photographs and video can be manipulated, and with the advancement of editing techniques, detection of tampered images and audio can be difficult. Consequently, verification of photograph and video authenticity has certain business and social implications. For example, image authenticity is crucial in fields such as journalism, scientific publishing, copyright protection, and legal matters. Manipulated images can be used to spread misinformation and fake news, and photograph or video authenticity can be required for submission as evidence in court.

However, determining whether a photograph or video has been altered can be a complex and cost-prohibitive process. Falsified images can be difficult to identify unless integrity detection algorithms have been implemented. A need exists for automatic transmission of still image and video data at the moment of capture that is cost-effective and eliminates reliance on any third party.

### SUMMARY

The disclosed subject matter provides systems and methods for collecting and distributing a digital audiovisual item captured by a sensor using a blockchain server. An example system can include a security module and a blockchain-enabled hardware. The system can further include a connectivity hardware for a cellular, a WIFI, and/or a Bluetooth connection. The security module can be coupled to the sensor and generate a private cryptographic key. The blockchain-enabled hardware can be coupled to the sensor and the security module. The blockchain-enabled hardware can generate a set of original hashes corresponding to the captured digital audiovisual item and an identifier having an address to the original hashes. The blockchain-enabled hardware can also embed information corresponding to the identifier in the captured digital audiovisual item to create a blockchain identified audiovisual item and post the set of original hashes to a public blockchain using the private cryptographic key.

In certain embodiments, the blockchain-enabled hardware can further receive a candidate digital audiovisual item corresponding to the blockchain identified audiovisual item, generate a set of candidate hashes corresponding to the candidate digital audiovisual item, and compare the set of original hashes to the set of candidate hashes to determine whether the candidate digital audiovisual item includes information from the blockchain identified audiovisual item that has been manipulated.

In some embodiments, the blockchain-enabled hardware can revoke the private cryptographic key upon loss of communication to the public blockchain and/or tampering of said hardware. The security module can detect physical, electronic, and data tampering. The security module can include a physical tamper detection box which can detect any unauthorized physical damages or accesses to the system. The security module can also include a secure cryptoprocessor which can store, hash, and encrypt the digital audiovisual item to protect the system from the tampering. The security module can further include a real-time clock which can be independent from any network time protocols.

In non-limiting embodiments, the blockchain-enabled hardware can further perform a spectral analysis on the captured digital audiovisual item to verify a location and a time of capture. In certain embodiments, the digital data can include a video clip, an image, and/or an audio clip. In some embodiments, the information corresponding to the identifier can include a response received from the public blockchain in response to posting the identifier.

In certain embodiments, a smart contract can be encoded on a blockchain server. The system can communicate with the blockchain server through the smart contract. For example, the system can send and receive cryptographic hashes of the digital audiovisual item from the blockchain server using the smart contract. The contract can confirm authenticity and connectivity of the system.

The disclosed subject matter also provides methods for collecting and distributing a digital audiovisual item using the disclosed system. An example method can include capturing the digital audiovisual item, generating a set of original hashes corresponding to the captured digital audiovisual item and an identifier having an address to the original hashes, embedding information corresponding to the identifier in the captured digital audiovisual item to create a blockchain identified audiovisual item, generating a private cryptographic key, and posting, by a blockchain-enabled camera, the set of original hashes to a public/private blockchain using the private cryptographic key. In non-limiting embodiments, the exemplary method can further include receiving a candidate digital audiovisual item corresponding to the blockchain identified audiovisual item, generating a set of candidate hashes corresponding to the candidate digital audiovisual item, and comparing the set of original hashes to the set of candidate hashes to determine whether the candidate digital audiovisual item includes information from the blockchain identified audiovisual item that has been manipulated. In some embodiments, the exemplary method can also include revoking the private cryptographic key upon loss of communication to the public/private blockchain and/or tampering of the blockchain-enabled camera.

### BRIEF DESCRIPTION OF THE DRAWINGS

Further features and advantages of the present disclosure will become apparent from the following detailed description taken in conjunction with the accompanying figures showing illustrative embodiments of the present disclosure, in which:

FIG. 1 is an illustration of an exemplary blockchain-embedded system in accordance with the present disclosure.

FIG. 2 is a flow diagram illustrating a process implemented by the smart-contract blockchain-enabled hardware to post data related to an audiovisual item on a public blockchain.

FIG. 3 is a flow diagram illustrating a process implemented by the smart-contract blockchain-enabled hardware to verify if an audiovisual item has been manipulated.

FIG. 4 is an illustration of an exemplary blockchain-embedded system in accordance with the present disclosure.

FIG. 5 is an illustration of detection of image manipulation.

FIG. 6 is an exemplary hardware diagram in accordance with the present disclosure.

Throughout the figures, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments.

### DETAILED DESCRIPTION

The disclosed subject matter provides techniques for collecting and/or distributing authenticatable video, audio, and images. The disclosed subject matter further provides techniques for converting a digital audiovisual item captured by a sensor into a blockchain identified audiovisual item is disclosed. An exemplary system can include a blockchain-enabled digital camera and a smart contract. The smart contract is configured to send and receive cryptographic hashes for video, audio, and images.

In certain embodiments, the disclosed system can comprise a local security module that can be coupled to a sensor and adapted to generate a private cryptographic key. The system additionally can include a smart-contract blockchain-enabled hardware, coupled to the sensor and the local security module. The hardware can generate a set of original hashes corresponding to the captured digital audiovisual item and an identifier having an address to the original hashes, embed information corresponding to the identifier in the captured digital audiovisual item to create a blockchain identified audiovisual item, and post the set of original hashes to a public blockchain using the private cryptographic key.

In some embodiments, the system provides an automatic and cost-effective method of verifying audiovisual authenticity. For example, the system can take a photograph or video, then generate a hash of the audiovisual data. The hash can be automatically and instantaneously posted to a public ledger on the blockchain while an address of the hash is embedded in the photograph or video. When the photograph or video is distributed from the camera system, the address information can be distributed in each image or video clip. Because data on the blockchain cannot be changed once it is posted, authenticity can be verified. For example, a photograph or video in question can be hashed. If the hash matches the hash on the blockchain, then the photograph or video is authentic. In some embodiments, a blockchain that enables smart-contracts is utilized. For example, an Ethereum and/or a Burst blockchain can be used.

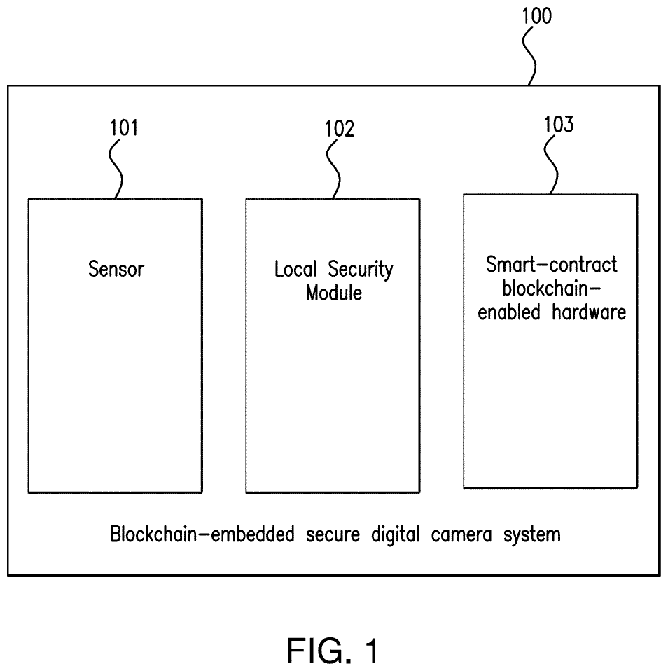

FIG. 1 is an illustration of an exemplary system in accordance with the present disclosure. As shown in FIG. 1, the disclosed system 100 can comprise a sensor 101, a local security module 102, and a smart-contract blockchain-enabled hardware 103. In some embodiments, the sensor 101 can include a digital camera. In non-limiting embodiments, the sensor 101 can record a video clip, an image, and/or an audio clip.

In certain embodiments, local security module 102 can comprise a physical computing device for storing and managing digital keys. For example, a private cryptographic key of the digital camera system can be stored on the local security module. The local security module can contain cryptoprocessor chips to prevent tampering. The module can back up the digital keys to other memory locations outside of the module. The module also can provide both physical and logical protection of the digital keys.

In some embodiments, smart-contract blockchain-enabled hardware 103 handles interactions with the blockchain. The hardware can perform functions related to preparing data for the blockchain and posting data to the blockchain. In non-limiting embodiments, the hardware can perform audiovisual verification functions. For example, the hardware receives candidate audiovisual data and determines whether the candidate audiovisual data is authentic based on a hash value, GPS data, spectral data, or any other data. The hardware can execute hash functions on audiovisual data. For example, the hardware executes a hash function that generates a set of hash values based on audiovisual data.

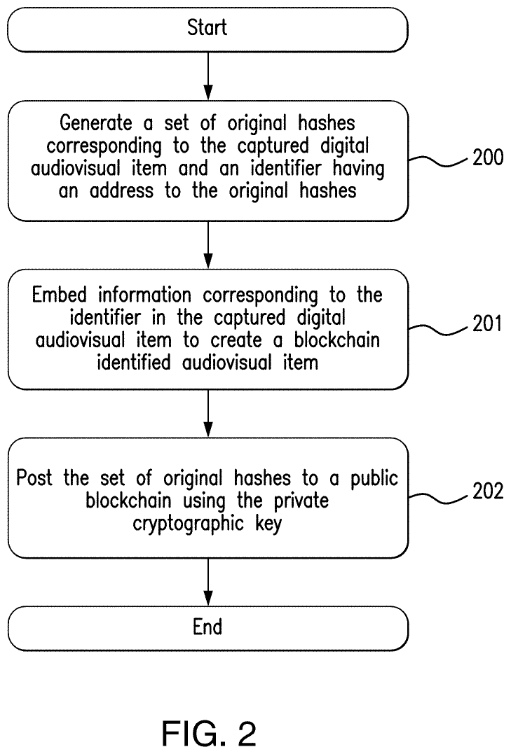

FIG. 2 is a flow diagram illustrating a process implemented by the smart-contract blockchain-enabled hardware to post data related to an audiovisual item on a public blockchain. In certain embodiments, the process can be implemented by hardware 103 of FIG. 1. As shown in 200, the hardware can generate a set of original hashes corresponding to the captured digital audiovisual item and an identifier having an address to the original hashes. For example, the set of original hashes is not the audiovisual item itself but is a result of a hash function performed on the audiovisual item (e.g. a numerical value). The set of original hashes cannot be interpretable by itself. In some embodiments, the unique identifier can comprise a pointer, an address, or any other location information. It can describe the location on the public blockchain where the set of original hashes is posted. The identifier can be a number or other descriptor. For example, the identifier can be an integer (e.g., 123456789) or a hash (e.g., fdb6e3a30b09bb82c559a0beab94715b).

As shown in 201, in certain embodiments, the hardware embeds information corresponding to the identifier in the captured digital audiovisual item to create a blockchain identified audiovisual item. For example, a captured photograph, video clip, or audio clip can be embedded with the identifier. The identifier can be stored in metadata of the image file. The metadata is a set of data that can describe and give information about the image file. The metadata can include administrative data, descriptive data, and rights. When the audiovisual item is provided from the camera system, the identifier can be inseparable from the audiovisual item. For example, every photograph that is taken with the camera system and distributed can carry with it the blockchain identifier.

In some embodiments, global positioning system (GPS) data or other metadata can be appended to the image hash. Such metadata can provide further security because the metadata can be checked for a match to prove authenticity. In some embodiments, the information corresponding to the identifier comprises a response received from the public blockchain in response to posting the identifier thereto. For example, when the system posts to the blockchain using a smart contract, the smart contract can return certain predefined data such as image's unique identifier.

As shown in 202, in certain embodiments, the hardware posts the set of original hashes to a public blockchain using the private cryptographic key. Using the private cryptographic key to make the post can signify that the post came from the specific camera system in question. For example, only the specific camera system has access to the private key. A public key for the camera system can be publicly posted and accessible. A third party can perform a verify function using the camera system's public key to determine whether the hash was posted by the camera system or by another party.

In some embodiments, the hardware 103 of FIG. 1. can be equipped with a cellular, radio, satellite, or other communications chip. The chip can serve as the communication point with the blockchain and send messages about device tampering. For example, a lost connection between the camera system and the blockchain can indicate that the camera system is being tampered with. The camera system can perform certain alarming actions when it detects a lost connection and tampering. For example, the camera system can provide an indication to a user (e.g. via a user interface).

In some embodiments, the blockchain-enabled hardware can further revoke the private cryptographic key upon loss of communication to the public blockchain and/or tampering of said hardware. Audiovisual data captured by the camera system from that point forward cannot be posted with the private cryptographic key of the camera system and cannot be verified. In some embodiments, the camera system's blockchain privileges can be automatically revoked when a lost connection or other tampering is detected. For example, the blockchain-enabled hardware can automatically stop generating hash sets or posting hash sets of the audiovisual data.

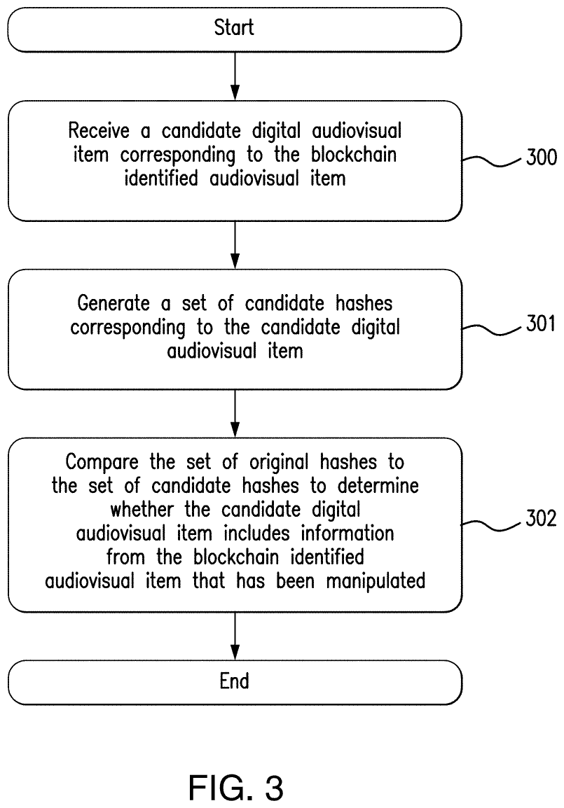

FIG. 3. is a diagram illustrating a process implemented by the smart-contract blockchain-enabled hardware to verify if an audiovisual item has been manipulated. In some embodiments, smart-contract blockchain-enabled hardware 103 of FIG. 1. is further configured to verify authenticity of an audiovisual item and the process in FIG. 3. is implemented by hardware 103.

In certain embodiments and as shown in 300, the hardware can receive a candidate digital audiovisual item corresponding to the blockchain identified audiovisual item 300. For example, the blockchain identified audiovisual item can comprise a video clip with audio inputs, wherein the camera system was originally used to record the video clip with audio inputs. A video clip in a user's possession is the candidate digital audiovisual item. The user can verify whether the candidate video clip is authentic or if it is a manipulated version of the original video clip.

In certain embodiments and as shown in 301, the hardware can generate a set of candidate hashes corresponding to the candidate digital audiovisual item. The hash function executed to generate the set of candidate hashes can be stored on the hardware or in the camera system that the hardware is a part of. The hash function can be the same hash function that was used to generate the set of original hashes to store on the blockchain when the audiovisual item was recorded. In some embodiments, the hash function can be stored publicly so that third parties can perform verification. For example, verification can be performed by devices other than the camera system that originally recorded the audiovisual data.

In certain embodiments and as shown in 302, the hardware can compare the set of original hashes to the set of candidate hashes to determine whether the candidate digital audiovisual item includes information from the blockchain identified audiovisual item that has been manipulated. For example, the set of original hashes that are stored on the blockchain can be compared to the set of hashes that are calculated from the audiovisual item that is being verified. In some embodiments, a match of the sets of hashes can indicate that the candidate digital audiovisual item is authentic. For example, the user's video clip has not been modified and portrays images and audio as originally recorded. If the sets of hashes do not match, the candidate audiovisual item can be determined to be manipulated. In some embodiments, an indication of the authenticity of the audiovisual item can be provided to a user. For example, the camera system can comprise a user interface.

In some embodiments, the blockchain-enabled hardware can perform a spectral analysis on the captured digital audiovisual item to verify a location and a time of capture. For example, variations in the spectra captured at the time the image was claimed to be taken can be verified by spectral variations from the sun at that location or time. The hardware can analyze the spectra in the candidate audiovisual item and compare the spectra to the known spectra at the claimed location or time.

In some embodiments, the blockchain-enabled hardware can be equipped with a GPS to further authenticate images. The hardware can check that the GPS data of a candidate audiovisual item matches the expected GPS data based on the claimed location. The hardware can compare the GPS data of a candidate audiovisual item to GPS data that is appended to a hash stored on the blockchain or otherwise stored on the blockchain.

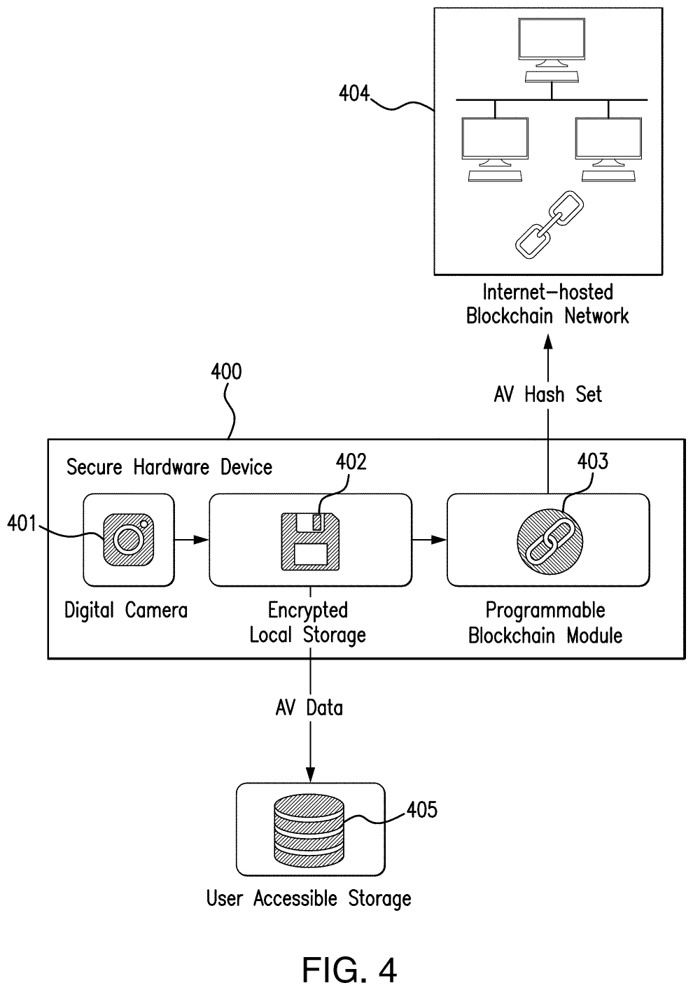

FIG. 4. shows an exemplary blockchain-embedded system in accordance with the present disclosure. In the example shown, secure hardware device 400 can include a digital camera 401, an encrypted local storage 402, and a programmable blockchain module 403. In some embodiments, secure hardware device 400 can comprise a blockchain-embedded secure digital camera system. In some embodiments, digital camera 401 captures digital audio, visual, or audiovisual data. A hash set of the data can be created. As shown, the programmable blockchain module 403 can provide an audiovisual hash set to internet-hosted blockchain network 404. Blockchain network 404 can comprise an Ethereum network or other smart-contract enabled blockchain network. The audiovisual hash set can be posted to a public ledger.

As shown FIG. 4, the encrypted local storage 402 can provide audiovisual data to user accessible storage 405. Audiovisual data embedded with information on the location of where the audiovisual hash is posted can be stored in user accessible storage 405. In non-limiting embodiments, the encrypted local storage can be memory for the camera that is outside of the user's control. It is stored within the secure device to protect against user tampering. Accordingly, the local storage can store the audiovisual data during the stage when the data is hashed and that set of hashes are uploaded to the blockchain. Afterward, it can be moved to user accessible storage. In some embodiments, the user can access the data from storage 405 and distribute the data.

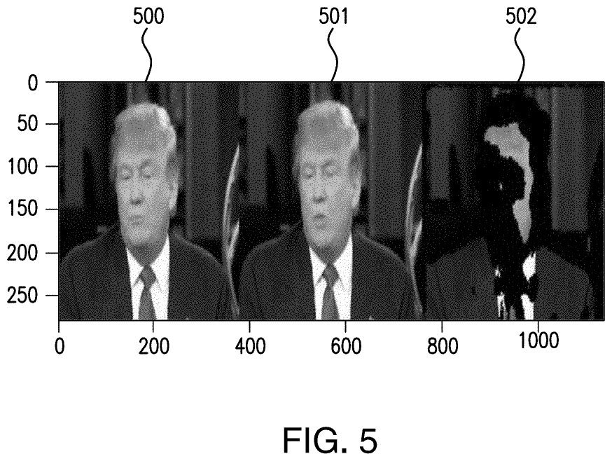

FIG. 5. is an illustration of exemplary detection of image manipulation. In some embodiments, the process described in FIG. 3. can be used to detect image manipulation as is shown. As shown, image 500 is an authentic image taken from a camera. Image 501 is a candidate image (e.g. the authenticity of the image is in question). In image 502, the mismatched portions of image 501 and 500 are indicated by black patches. For example, those portions with black patches of the image are manipulated in image 501.

In certain embodiments, the disclosed blockchain-enabled digital camera can comprise a microcomputer including a software. The microcomputer can include a CPU, a memory, and/or a graphic processing unit. In addition to the general usage of digital camera, the microcomputer allows additional functions for uploading authenticated images and video files to the blockchain server. For example, a request to take a photo can be mediated by the Blockchain Camera device software. The software can access the digital lens and retrieve the image/video. The software can transform the image/video into a cryptographic hash and compress the cryptographic hash to conform any data limitations of the blockchain. In non-limiting embodiments, the software can also create a new image using its unique device identifier. The blockchain server can confirm the authenticity of the user/device using the device identifier, assign an image identifier, and returns the image identifier to the device. The device can use the image identifier to upload the corresponding hash (or many hashes as in the case of a video) to the blockchain server. Then, the blockchain sever can return a confirmation signal that the hash is received and stored on the blockchain server. In non-limiting embodiments, the disclosed device can utilize a hash matrix where each element of the matrix can be a hash that corresponds to each pixel or subsection of an audiovisual file (e.g., audio, image, video). For example, a hash can be generated by iterating through each pixel of an audiovisual element and hashing the audiovisual element using a cryptographic function (e.g., sha256). The result of the iterative process can be a hash matrix which can be further compressed and uploaded to the blockchain. In some embodiments, the blockchain-enabled digital camera can store the image and the blockchain image identifier into memory/storage that is accessible by the authenticated user.

In certain embodiments, the disclosed software can include at least one class for the intended functions. The software can be configured to capture images, video and audio, encrypt and hash images, video, and audio, provide blockchain connectivity, and/or perform suite of image, video, and audio processing tasks. For example, the software can provide functions to connect to blockchain using web3 sockets, to create a new video object on the blockchain and retrieve a unique identifier, to add a frame to a video object on the blockchain, and to detect manipulation between a given video or image and the video or image's reference blockchain hash.

In certain embodiments, the disclosed software can include a class (e.g., ImageHash) which can be a new type of object that can have both an image (e.g., jpg, png, tiff, etc.) and a cryptographic hash of that object. The cryptographic hash can be compressed using a custom lossy compression algorithm so that it can be transferred to and from the blockchain. This object also can be loaded without a companion image which can be used in the image verification process. Furthermore, the class can create a new ImageHash object and save the image hash to disk/memory. The image can be exported to a custom output file type (e.g. jpg, png, tiff, etc). In non-limiting embodiments, the class can load a hash from a string object and convert a hash to a string object. Using the class, the disclosed software can create a cryptographic hash from an image file. The software can compress and upload the hash to the blockchain. In some embodiments, the software can compare ImageHash objects to each other (e.g., image verification) and create a composite image that shows where image fails verification. In some embodiments, the disclosed software can include an object which can represent a video and its corresponding hash (e.g., VideoHash). The Videohash object can be a collection of ImageHash objects.

In certain embodiments, the disclosed software can include a class which can receive a deep fake image generated by any state-of-the-art technology available and modify it to remove obvious defects. The class (e.g., BetterFake) can be applied to deep fake videos and images. The disclosed software, using the class, can merge two frames of a source video and a fake video and create a better fake frame/video. For example, the BetterFake, a python module, can remove inconsistencies in a deep fake audiovisual element. When algorithms such as deep learning or artificial intelligence algorithms are used to modify (or generate) an audiovisual file, various alternations can be made (e.g. color changes in the background, and unintended addition of noise which is not contribute to the goal of the fake). BetterFake analyzes audiovisual files and corrects these alternations.

In certain embodiments, the disclosed system can include a smart contract for sending and receiving cryptographic hashes for video, audio, and images. The smart contract can be encoded on a blockchain and connected to a device (e.g., blockchain-enabled digital camera). The smart contract can include at least one code designed for the intended purposes. For example, the smart contract can code for data structures to hold a Frame, a hashed (cryptographic) version of an image, frame of a video, a video, and/or linked list of Frames. The frame can be a generated data structure which can accommodate a section of an audio clip (e.g., 1 second). An audio/video file hash can be a linked list of such frames. In non-limiting embodiments, the smart contract can include codes which enable arrays of created Frames, images, videos. The smart contract can include codes for a dictionary which can map videos to a device that uploaded the videos. In some embodiments, the software can perform various functions using the codes.

For example, an exemplary function can confirm the authenticity of the device and create a new hash video/image object. Certain functions can add a frame to a video/image, receive a frame from a video/image, receive additional details of a video/image (e.g., owner, length, etc.), and receive all of the video/images a designated device (e.g., owner). In non-limiting embodiments, such functions can be executable only by a software owner or a designated user. For example, only authenticated devices can communicate with the smart contract using their private cryptographic key. The software can de-authenticate a device from uploading any further videos/images or executing any other smart contract functions. Only an authenticated device can execute the disclosed functions. In some embodiments, the software can also include a function to record a “check-in” from each device to confirm connectivity. For example, any devices that have lost connectivity to the blockchain can be de-authenticated for potentially being tampered. The disclosed codes can be written in solidity, the blockchain programming language for Ethereum.

The disclosed subject matter can provide codes for a webserver. The codes can be designed to serve a publicly accessible webserver and verify an authenticity of provided images. For example, the server can perform functions to upload an image/video and a blockchain unique identifier, compute a hash of the image/video (e.g., from ImageHash above), compare the image/video to the hash (e.g., from ImageHash above) and return a side-by-side image/video with the manipulated regions blacked out. To verify an authenticity of images, a user can have images (or video) and its corresponding blockchain identifier. The identifier can be embedded into the file's metadata for image/video file formats. When a user uploads the image/video file with an identifier to a web server, the web server can create a cryptographic hash of the uploaded image. The web server can retrieve the cryptographic hash stored on the blockchain using the provided image identifier. The web server can also compare at least two cryptographic hashes and identify manipulated regions. The web server can provide a composite image that can show the uploaded image side-by-side with a masked image showing the manipulated region (e.g., FIG. 5). In non-limiting embodiments, the server can include a server-based application that can monitor the connectivity of all devices. The application can be executed on a secure server on a continual basis. For example, the application can retrieve all currently authenticated devices from the blockchain, identify any devices that have lost communication (e.g., disconnected devices), and de-authenticate disconnected devices. In some embodiments, the codes can be served using the node and flask webserver software.

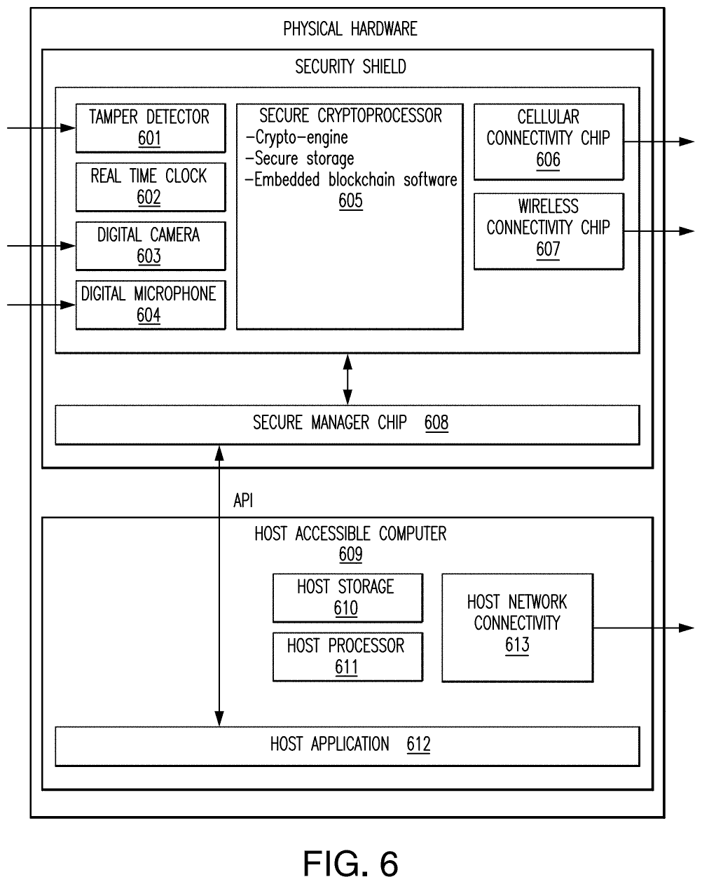

In certain embodiments, as shown in FIG. 6, the disclosed blockchain-enabled digital camera can further include a digital camera lens 603, microphone 604, and a connectivity hardware (e.g., cellular 606, WIFI 607, and Bluetooth 607). For example, the disclosed blockchain-enabled digital camera can include 802.11b/g/n wireless LAN, a Bluetooth 4.1, a Bluetooth Low Energy (BLE), 1 GHz, single-core CPU, a 512 MB RAM, a Mini HDMI and USB On-The-Go ports, a Micro USB power, a HAT-compatible 40-pin header, a Composite video and reset headers, a CSI camera connector, an 8 MegaPixel Camera, a case, a Camera Cable, and a Geeetech SIMCOM SIM900 Quad-band GSM GPRS Shield Development Board.

In certain embodiments, the disclosed system can include a secure hardware module. The secure hardware can be integrated into the system and provide security. The disclosed secure hardware can secure the blockchain-enabled digital camera from physical and digital attacks. The physical attacks can include physical tampering, dust, dirt, water, stealing, and memory. The digital attacks can include debugging without permission, module overwriting, change in code base, and digital tampering. For example, if any physical or digital tampering is detected, the secure hardware module can trigger a de-authentication event by sending a notification to the blockchain to de-authenticate the attacked device. Physical tampering can be detected by having a case that creates a circuit around the hardware. If the circuit is broke (in the event it is being removed), the secure hardware can trigger the device's tampering protocols. Electronic (digital) tampering can be detected when an unexpected electrical connection is made with the device (e.g., connecting a USB, HDMI, SD card, etc.) using pins which can be programmed to detect such connections (e.g., General Purpose Input Output (GPIO)). Data tampering can be prevented by using the cryptoprocessor to encrypt any data that is stored, received, or transmitted from the device. The cryptoprocessor can be used to detect tampering and trigger the device's tampering protocols.

The blockchain can have registered device IDs and remove the reported device from a list of authenticated devices. Any further communication or requests to execute smart contract functions from the reported device can be rejected.

In certain embodiments, the disclosed secure hardware can include a secure cryptoprocessor 605. The secure cryptoprocessor 605 can store data removing risk of memory card stealing and hacking. The secure cryptoprocessor 605 can also perform cryptographic encryption by executing encryption and hashing function tasks. For example, a microchip (e.g., ATECC608A and NXP C29) can be used as a secure cryptoprocessor 605 to contain a secure storage area and perform encryption and hashing functions. The cryptoprocessor can include a Elliptic Curve Diffie Hellman (ECDH) security protocol to provide an agreement for encryption/decryption, along with ECDSA (Elliptic Curve Digital Signature Algorithm) sign-verify authentication. The cryptoprocessor can also include a hardware-based cryptographic key storage and cryptographic countermeasures which can prevent potential backdoors linked to software of the device. In non-limiting embodiments, the disclosed secure hardware can comprise a real time clock 602. The real time clock can be embedded into the secure hardware removing any risks introduced by relying on the network time protocol. In some embodiments, the disclosed secure hardware can include a security manager chip 608. The security manager chip can function as an interface isolating other components of the blockchain enabled camera within the secure module. For example, the security manager chip can be a co-processor that can serve as the sole interface with the device and the user's computer. In non-limiting embodiments, the input/output of a device can be controlled by the security manager chip. The security manager chip can monitor access to the device and trigger a de-authentication protocol if tampering is detected. In non-limiting embodiments, the disclosed secure hardware can include a physical tamper detection box 601 which can de-authenticate a device when any physical attacks or access are detected.

In certain embodiments, the disclosed system can communicate with a host accessible computer. The host accessible computer can be any computer that can access the disclosed blockchain-enabled camera. For example the host accessible computer can a mobile phone, a mobile computer, a computer screen, a videography equipment, a mobile camera, and etc. The host accessible computer can include a host storage, a host processor, a host network connectivity chip, and/or host application.

In certain embodiments, the disclosed secure hardware can provide multiple levels of security to protect from the physical and digital attacks. In non-limiting embodiments, the secure hardware can be configured to provide a physical tampering level of security. The physical tampering level of security can be triggered when a device is forced to open. For example, an electronic circuit can be located around a device. When the device is forcefully opened, the circuit can be broken triggering de-authentication. In non-limiting embodiments, the secure hardware can be configured to provide an electronic tampering level of security. For example, the disclosed blockchain enabled camera can include a General Purpose Input Output (GPIO) of the device which can be programmed to detect if any unexpected connection is made in the input ports. The electronic tampering level of security can protect a device from an electronic connection without proper authentication (e.g., inserting a USB, HDMI, or other device). In some embodiments, the secure hardware can be configured to provide a data tampering level of security. All data within the disclosed device can be cryptographically stored to prevent digital access and manipulation. The security hardware with the data tampering level of security can protect an image, video, and/or audio file from access without authentication, manipulation, and tampering.

In certain embodiments, the disclosed system can be used for digital image authentication, identification of malicious image manipulation, and digital asset management. The system also can be used as an image forensics tool for identification of forged documents or artwork. In some embodiments, the blockchain-embedded secure digital camera system can be used in applications comprising: verifiable security cameras, CCTV systems, dashcams, body cameras; blockchain-based biometric identity management (facial recognition, iris scans); secure medical image (e.g. dental, CT, MRI) acquisition and authentication; and verifiable scientific imaging (e.g. microscopy, Western blots) for improved scientific integrity, among others.

In certain embodiments, smart-contract blockchain-enabled hardware as used in the claimed system can post to blockchains that have implemented the capability of smart contracts. Smart contracts can allow the network of computers connected to a blockchain to operate as a general purpose and programmable computer. These blockchains can process transactions with improved speed, efficiency, and data storage. For example, a camera system utilizing a smart-contract blockchain-enabled hardware can store a 10 second video (15 fps) in less than 10 minutes at marginal cost. In comparison, a new block of 2,020 transactions can be added to the Bitcoin blockchain every 10 minutes. Each transaction can require 10 minutes or longer to post, and can take up to 24 hours. A single 10 second video stored at 15 frames per second can require 45 minutes to post. However, that requires only the video's transactions to be processed and all other transactions ignored. The transaction can post between 5 days and a few weeks. In addition to a transaction amount, transaction fees can be incurred; A single image can cost around $100 and a 10 second video at 15 fps approximately $15,000.

In some embodiments, using a smart-contract enabled blockchain in the claimed system can allow immediate posting of a hash of audiovisual data. Because smart-contract enabled blockchains are not constrained by transaction time or cost, the disclosed system can immediately post a hash when the audiovisual data is recorded when using a smart-contract enabled blockchain. In certain constrained systems, a third party is required to congregate hash values and post at large intervals (e.g. once a day) to the blockchain. The third party can manipulate the data or be hacked. However, the disclosed system can eliminate the use of third parties and also provides an instantaneous solution when using a blockchain that enables smart-contracts. For example, the hash of the audiovisual data can be calculated and posted without delay.

In certain embodiments, the disclosed blockchain-enabled camera can obviate a trust requirement between a recipient and a sender by storing data on—and maintaining a connection with—a smart contract-capable public blockchain. Each image can be independently verifiable by any third-party. This process of verification does not require trust between the recipient and the sender nor between the recipient and the digital camera/lens manufacturer.

In certain embodiments, the blockchain-enabled camera can house a camera and blockchain software within a secure hardware module. As the blockchain software and hardware can be embedded together within the secure hardware module, there can be no separation of the data capture and cryptographic hashing. This feature can protect the system from data manipulation that occurs to images before their cryptographic fingerprints are sent to a blockchain.

In non-limiting embodiments, the hardware module can detect when a user attempts to tamper with the device physically and will trigger the device to de-authenticate itself from posting to the public blockchain. The Blockchain Camera can have software and hardware that can detect any tampering with the device and will trigger immediate and permanent de-authentication. For example, the software can be designed to detect both manipulation en masse and specific manipulation. The software can identify subtle manipulation of image, video, and audio files (e.g., a small portion of an image). Further, the software can make honest adjustments of the files (e.g. compression, color correction, noise reduction) without invalidating the authenticity. The blockchain-enabled camera can include audiovisual editing software. The user can request the blockchain-enabled camera to make honest manipulations (e.g., color correction, compression, and noise reduction, among others), these manipulations can be logged, hashed, and then stored on the blockchain. The logged manipulations would be embedded in the image so that they can be verified by a third party. Since all of these manipulations can be occurred within the device itself, they can be tracked. Any further post-processing by the user to the audiovisual file can be detected.

In certain embodiments, the blockchain-enabled camera can produce files that can be independently verifiable using public and private cryptographic keys. Any third-party can verify the source and content of an image, video, or audio file.

It will be understood that the foregoing is only illustrative of the principles of the present disclosure, and that various modifications can be made by those skilled in the art without departing from the scope and spirit of the present disclosure.

What is claimed is:

1. A system for collecting and distributing a digital audiovisual item captured by a sensor using a blockchain server, comprising:
a security module, coupled to the sensor, adapted to generate a private cryptographic key; and
a blockchain-enabled hardware, coupled to the sensor and the security module, and configured to:
generate a set of original hashes corresponding to the captured digital audiovisual item and an identifier having an address to the original hashes,
embed information corresponding to the identifier in the captured digital audiovisual item to create a blockchain identified audiovisual item, and
post the set of original hashes to a public/private blockchain using the private cryptographic key.

2. The system of claim 1, wherein the blockchain-enabled hardware is further adapted to:
receive a candidate digital audiovisual item corresponding to the blockchain identified audiovisual item,
generate a set of candidate hashes corresponding to the candidate digital audiovisual item, and
compare the set of original hashes to the set of candidate hashes to determine whether the candidate digital audiovisual item includes information from the blockchain identified audiovisual item that has been manipulated.

3. The system of claim 1, wherein the digital audiovisual item includes a video clip, an image, and/or an audio clip.

4. The system of claim 1, wherein the blockchain-enabled hardware is further adapted to perform a spectral analysis on the captured digital audiovisual item to verify a location and a time of capture.

5. The system of claim 1, wherein the information corresponding to the identifier comprises a response received from the public/private blockchain in response to posting the identifier thereto.

6. The system of claim 1, wherein the security module is adapted to revoke the private cryptographic key upon loss of communication to the public/private blockchain and/or tampering of said hardware.

7. The system of claim 6, wherein the tampering includes physical tampering, electronic tampering, and data tampering.

8. The system of claim 7, wherein the security module includes a physical tamper detection box which detects any unauthorized physical damages or physical accesses to the device.

9. The system of claim 6, wherein the security module includes a secure cryptoprocessor which is adapted to store, hash, and encrypt the digital audiovisual item.

10. The system of claim 10, wherein the security module includes a real-time clock which is independent from any network time protocols.

11. The system of claim 1, further comprising a connectivity hardware for a cellular, a WiFi, and/or a Bluetooth connection.

12. The system of claim 1, a smart contract is encoded on the blockchain server connected to the system, wherein the smart contract is adapted to:
connect the blockchain server to an authenticated device for communicating the cryptographic hashes of the digital audiovisual item.

13. The system of claim 12, the smart contract is further adapted to confirm authenticity and connectivity of the system.

14. A method for collecting and distributing a digital audiovisual item comprising:
capturing, by a blockchain-enabled camera, the digital audiovisual item;
generating, by the blockchain-enabled camera, a set of original hashes corresponding to the captured digital audiovisual item and an identifier having an address to the original hashes,
embedding, by the blockchain-enabled camera, information corresponding to the identifier in the captured digital audiovisual item to create a blockchain identified audiovisual item,
generating, by the blockchain-enabled camera, a private cryptographic key; and
posting, by a blockchain-enabled camera, the set of original hashes to a public/private blockchain using the private cryptographic key.

15. The method of claim 14, further comprising:
receiving, by the blockchain-enabled camera, a candidate digital audiovisual item corresponding to the blockchain identified audiovisual item,
generating, by the blockchain-enabled camera, a set of candidate hashes corresponding to the candidate digital audiovisual item, and
comparing, by the blockchain-enabled camera, the set of original hashes to the set of candidate hashes to determine whether the candidate digital audiovisual item includes information from the blockchain identified audiovisual item that has been manipulated.

16. The method of claim 15, further comprising:
revoking the private cryptographic key upon loss of communication to the public/private blockchain and/or tampering of the blockchain-enabled camera.
